(19) United States
(12) Patent Application Publication
(10) Pub. No.: US 2010/0150245 A1
(43) Pub. Date: Jun. 17, 2010

(54) Multimedia Stream Selection

(75) Inventors: William O. Camp, JR., Chapel Hill, NC (US); Mark Gavin Kokes, Raleigh, NC (US); Maurice J. Labiche, Cary, NC (US); Yojak Harshad Vasa, Cary, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/335,035

(22) Filed: Dec. 15, 2008

(51) Int. Cl. H04N 7/26

(52) U.S. Cl. 375/240.25

(57) ABSTRACT

Two or more video streams including a high quality video stream and a low quality video stream are simultaneously transmitted to the mobile communication device over the wireless network. All of the video streams carry the same video content but with different video quality. The high quality video stream is transmitted with a relatively low margin and the low quality video stream is transmitted with a relatively high margin. The mobile communication device can select the high quality video stream when channel conditions are favorable, and may select the low quality video stream when the channel conditions are not good enough to support the high quality video stream.

### BACKGROUND

The present invention relates generally to methods and apparatus for video distribution in a wireless communication system and, more particularly, to methods and apparatus for coding video for transmission over wireless networks to mitigate fast fading effects.

Mobile communication devices, such as cellular telephones and personal digital assistants, are now capable of high-speed data communications. Users of mobile communication devices can now surf the web, send and receive email messages, chat with friends, view images, play music, and perform other tasks that previously required a computer. With increasing data rates and bandwidths, along with larger displays, it is now possible to stream high quality video content from a video server to users for viewing on their mobile communication devices.

Selective fading can present a problem when delivering video content over wireless networks. Mobile communication devices may experience rapid changes in channel conditions, particularly in indoor environments. If channel conditions degrade, it may not be possible to support the data rates necessary to deliver high quality video content. In such instances, the video output to the display may be corrupted, or possibly even interrupted, resulting in an unfavorable user experience. Link adaptation responsive to changing channel conditions could be used to mitigate the effects of fading. However, link adaptation requires feedback from the receiving device to the transmitting device. Further, link adaptation may be more useful in slow fading conditions than in fast fading conditions due to the lag between the time that the receiving device reports channel conditions and the time that the modulation and coding can be adapted.

Accordingly, there is a need for new methods to mitigate the effects of fast fading when delivering video to mobile communication devices over wireless networks.

### SUMMARY

The present invention provides a method and apparatus for delivering video content to mobile communication devices over wireless networks. According to the present invention, two or more video streams carrying the same content but of different quality are simultaneously transmitted to the mobile communication device over the wireless network. Preferably, one stream is a high quality video stream transmitted with a relatively low margin, and one stream is a low quality video stream transmitted with a relatively high margin. The mobile communication device can select the high quality video stream when channel conditions are favorable, and may select the low quality video stream when the channel conditions are not good enough to support the high quality video stream.

Exemplary embodiments of the invention include methods implemented by a communication device for receiving video. One exemplary method comprises receiving a high quality video stream corresponding to selected video content; receiving a low quality video stream corresponding to the selected video content and synchronized with said high quality video stream, said low quality video stream being independently coded and transmitted so as to provide a relatively high margin compared to the high quality video stream; decoding said high quality video stream in a first channel decoder and a first source decoder; decoding said low quality video stream in a second channel decoder and a second source decoder; generating a first quality metric indicative of a received channel quality of the high quality video stream; and switching between high quality and low quality video streams based on said first quality metric.

In one exemplary method, switching between high quality and low quality video streams based on said first quality metric comprises switching from the high quality video stream to the low quality video stream when the first channel quality metric exceeds a first predetermined threshold.

In one exemplary method, decoding said low quality video stream comprises channel decoding and source decoding the low quality video stream only when the first channel quality metric exceeds a second predetermined threshold.

In one exemplary method, the second predetermined threshold is lower than the first predetermined threshold.

One exemplary method further comprises sending said first channel quality metric to a video transmission system for adapting the video quality of at least said high quality video stream responsive to said first channel quality metric.

One exemplary method further comprises generating a second channel quality metric indicative of the received channel quality metric of the low quality video stream and sending said first and second channel quality metrics to a video transmission system for adapting the video quality of said high quality and low quality video streams.

In one exemplary method, switching between high quality and low quality video streams based on said first quality metric comprises switching to a selected one of the high quality and low quality video streams at a time coincident with the start of an I-frame in the selected video stream.

Other embodiments of the invention comprise a communication device having a display for rendering a video stream. In one embodiment the communication device comprises a receiver to receive high quality and low quality video streams corresponding to selected video content from a video transmission device, said low quality video stream being independently coded and transmitted so as to provide a relatively high margin compared to the high quality video stream; a decoding circuit configured to decode said high quality video stream to generate a high quality video stream, generate a first channel quality metric for the high quality video stream, and decode said low quality video stream to generate a low quality video stream; a selection circuit for switching between said high quality and low quality video streams for output to said display; and a control unit for controlling said selection circuit based on the first channel quality metric.

In one embodiment of the communication device, the control unit is configured to switch from the high quality video stream to the low quality video stream when the first channel quality metric exceeds a first predetermined threshold.

In one embodiment of the communication device, control unit is configured to selectively enable and disable the decoding circuit for the low quality video stream based on said first channel quality metric.

In one embodiment of the communication device, control unit is configured to selectively enable the decoding circuit for the low quality video stream when said first channel quality metric is below a second predetermined threshold.

In one embodiment of the communication device, the first predetermined threshold is lower than the second predetermined threshold.

In one embodiment of the communication device, the control unit is further configured to send said first channel quality metric to a video transmission system for adapting source coding of said high quality video stream.

In one embodiment of the communication device, the decoding circuit is further configured to generate a second channel quality metric indicative of the channel quality of the low quality video stream and wherein said control unit is further configured to send said first and second channel quality metrics to a video transmission system for adapting the video quality of at least said high quality video stream.

In one embodiment of the communication device, the control unit is configured to switch to a selected one of the high quality and low quality video streams at a time coincident with the start of an I-frame in the selected video stream.

Other embodiments of the invention comprise method of transmitting video to a communication device. One embodiment of the method comprises receiving selected video content from a video source; encoding the selected video content in a first source coder and a first channel coder to generate a high quality video stream containing the selected video content; independently encoding the selected video content in a second source coder and a second channel coder to generate a low quality video stream containing the selected video content; transmitting said high quality video stream to the mobile communication device over a first channel; and transmitting the low quality video stream to the mobile communication device over a second channel with a relatively high power margin compared to the high quality video stream.

One exemplary method further comprises receiving channel quality feedback from said mobile terminal over an uplink channel; and varying the video quality of at least the high quality video stream responsive to said channel quality feedback from said mobile terminal.

On one exemplary method, varying the video quality of the high quality video stream comprises varying the resolution or color depth of the video stream.

In one exemplary method, varying the video quality of the high quality video stream comprises varying the source coding and/or channel coding video stream.

One exemplary method further comprises varying the video quality of the low quality video stream responsive to said channel quality feedback from said mobile terminal.

Other embodiments of the invention comprise video transmission system for transmitting video to a remote communication device over a wireless communication network. One embodiment of the video transmission system comprises a coding circuit configured to code video content to generate a high quality video stream; code video content to generate a low quality video stream; a transmitter for transmitting said high quality video stream and said low quality video stream over respective channels to the mobile terminal; and a control unit for controlling the said coding circuit and said transmitter to transmit said high quality video stream with a relatively low margin and to transmit said low quality video stream with a relatively high margin.

In one embodiment of the video transmission system, the control unit is configured to receive channel quality feedback from said mobile terminal over an uplink channel; and vary the video quality of the high quality video stream responsive to said channel quality feedback from said mobile terminal.

In one embodiment of the video transmission system, the control unit is configured to vary the resolution and/or color depth of the high quality video stream responsive to said channel quality feedback.

In one embodiment of the video transmission system, the control unit is configured to vary the source coding and/or channel coding of the high quality video stream responsive to said channel quality feedback.

In one embodiment of the video transmission system, the control unit is configured to vary the video quality of the low quality video stream responsive to said channel quality feedback from said mobile terminal.

### BRIEF DESCRIPTION OF THE DRAWINGS

FIG. 1 illustrates the main functional elements of a video distribution system according to one exemplary embodiment of the present invention for transmitting two or more video streams with the same video content but of varying video quality.

FIG. 2 illustrates the coding of two video streams with the same video content but of varying quality according to one exemplary embodiment of the invention.

FIG. 3 illustrates a video transmission system according to one exemplary embodiment of the invention for transmitting two or more video streams with the same video content but of varying video quality.

FIG. 4 illustrates the main functional elements in a pre-processor for the video transmission system.

FIG. 5 illustrates an exemplary video receiving system according to one exemplary embodiment of the invention for receiving two or more video streams with the same video content but of varying video quality.

FIG. 6 illustrates an exemplary method implemented by a video receiving system for autonomously switching between two or more video streams with the same video content but of varying quality.

FIG. 7 is a timing diagram that illustrates switch timing in one exemplary embodiment of the invention for switching between two or more video streams with the same video content but of varying quality.

FIG. 8 illustrates an exemplary method of adjusting the quality of one or more video streams transmitted from a video transmission system to a video receiving system.

### DETAILED DESCRIPTION

The present invention relates to a method of transmitting real-time multimedia streams, such as video streams, to a mobile terminal over a mobile communication network. The mobile terminal may comprise, for example, a cellular telephone, personal digital assistant, a computer, or other communication device. In a mobile communication network, the mobile terminal may encounter rapidly changing channel conditions due to selective fading. Video streams are typically transmitted to a mobile terminal with sufficient power margin to ensure a desired error performance under all expected channel conditions. However, if the power margin is too low, the mobile terminal may experience periods when the channel conditions will not support the data rates required to properly receive and decode the video stream. In such circumstances, the video stream may be corrupted or lost.

One way to avoid corruption or loss of the transmitted video stream is to increase the power headroom or margin allocated to the video stream. The power headroom or margin is the difference between the actual transmit power allocated for transmission of the video stream and the average transmit power needed to properly receive and decode the video stream. Increasing the power margin provides greater protection against corruption and loss of the video stream at the cost of reduced spectral efficiency.

According to the present invention, a portion of the power normally allocated to transmit a high quality (HQ) video stream is used instead to transmit one or more additional low quality (LQ) video streams with the same video content but of lower quality. The LQ video streams can be generated, for example, by reducing the resolution and/or color depth of the HQ video stream. The number of source coded bits in the LQ video streams may represent only 10% of the number of bits in the HQ video stream. Thus, a small reduction in the margin of the HQ video stream can provide sufficient power to transmit the LQ video stream with a high margin. For example, a 2-3 dB reduction in the margin for the HQ video stream may enable transmission of a LQ video stream with a 10 dB margin.

The high quality and low quality video streams can be synchronized, and transmitted to the mobile terminal over a mobile communication network. The video streams can be independently coded and transmitted over separate channels (e.g., time slots or codes) to the mobile terminal. The mobile terminal can then select the highest quality video stream for output to the display that is supported by the instantaneous channel conditions. When channel conditions are good, the mobile terminal can select the HO video stream. As channel conditions deteriorate, the mobile terminal can switch to a LQ video stream. By switching to a LQ video stream, interruption of the video can be avoided. Because the video streams are coded independently, the mobile terminal can use the LQ video stream even when the high quality video stream itself is unusable.

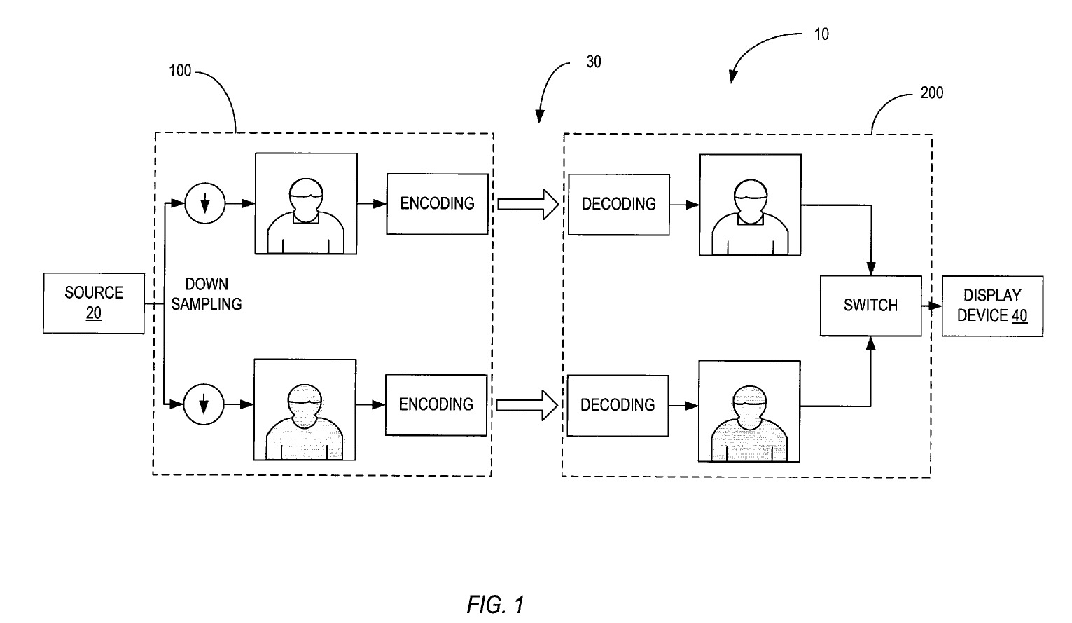

FIG. 1 illustrates the main functional components of a video distribution system 10 according to one exemplary embodiment of the present invention. The video distribution system 10 comprises a video transmission system 100 and a video receiving system 200. The video transmission system 100 may, for example, comprise a base station in a mobile communication network and the video receiving system 200 may comprise a mobile communication device, such as a cellular phone or personal digital assistant. The video transmission system 100 receives video content from a video source 20, generates multiple encoded source video streams with the same video content but of varying quality, and transmits the multiple encoded video streams over a wireless communication channel 30 to the video receiving system 200. In general, the video transmission system 100 generates at least two video streams: a high quality video stream and one or more low quality video streams. The terms high quality and low quality are not intended to imply a particular quality level, but instead are relative terms to indicate the relative quality of the video streams. Typically, there is a significant difference in the quality of each video stream.

The video receiving system 200 receives and decodes the video streams, generates one or more channel quality metrics indicative of the quality of each channel as seen by the video receiving system 200, and selects the highest quality video stream that is supported by the instantaneous channel conditions. Frame error rate (FER) is one example of a channel quality metric. The bit error rate (BER) could also be used as a channel quality metric. The selected video stream is output to a display device 40 for viewing by a user. When channel conditions are favorable and can support high data rates, the video receiving system 200 will select the high quality video stream for output to the display device 40. As channel conditions degrade, the video receiving system 200 will select one of the low quality video streams. By selecting a low quality video stream when channel conditions are not favorable, interruption of the video program may be avoided.

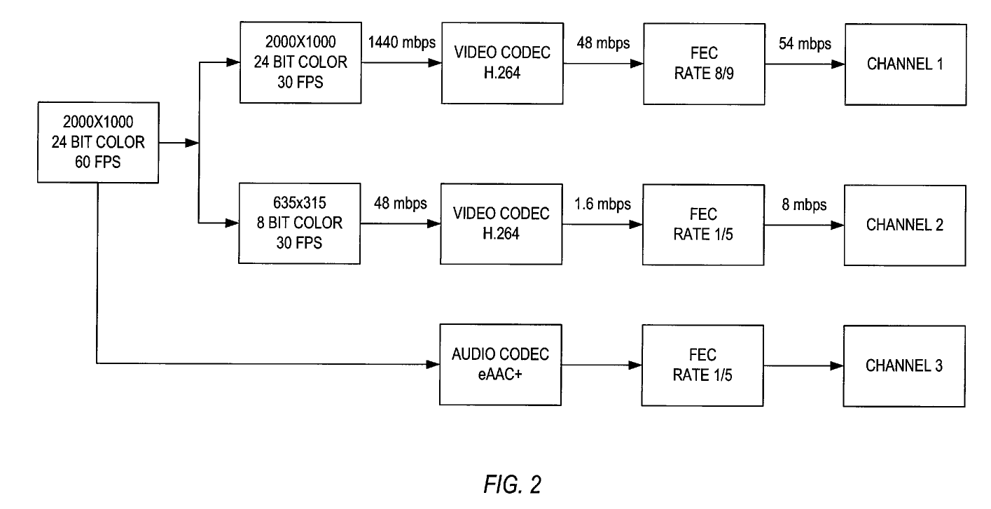

FIG. 2 illustrates the source and channel coding applied in one exemplary embodiment. The original video file comprises 60 frames per second (fps). Each frame is 2000×1000 pixels with 24 bit color. In this example, two video streams are generated from the same video content. The video streams are referred to herein as the high quality (HQ) video stream and the low quality (LO) video stream. The designations HQ and LQ do not imply a particular quality level, but instead, are meant to indicate the relative quality of the two streams. Those skilled in the art will appreciate that the coding scheme illustrated in FIG. 2 is only one example of the coding that may be applied and, therefore, the example is not intended to limit the invention.

The HQ video stream comprises 30 fps. Each frame is 2000×1000 pixels with 24 bit color. The resulting data rate for the HQ video stream is 1440 mbs. The HQ video stream is coded using an H.264 video codec. The output from the video codec is a 48 mbps video stream. Following source coding, the HQ video stream is protected with a rate 8/9 FEC code. The output from the FEC coder is a 54 mbps video stream.

The LQ video stream is created by downsampling the frames of the original video file to reduce the horizontal resolution, vertical resolution, and/or color depth of the video frames. In this exemplary embodiment, the LO video stream comprises 30 fps. Each frame is 635×315 pixels with 8 bit color depth. The resulting data rate for the LQ video stream is 48 mbps. The LQ video stream is coded using an H.264 video codec to generate a 1.6 mbps video stream. Following source coding, the LQ video stream is protected with a rate 1/5 FEC code. The output from the FEC coder is a 8 mbps video stream.

The audio stream is preferably encoded with a standard audio codec, such as the eAAC+ audio codec. The coded audio stream is then protected by a rate 1/5 FEC code.

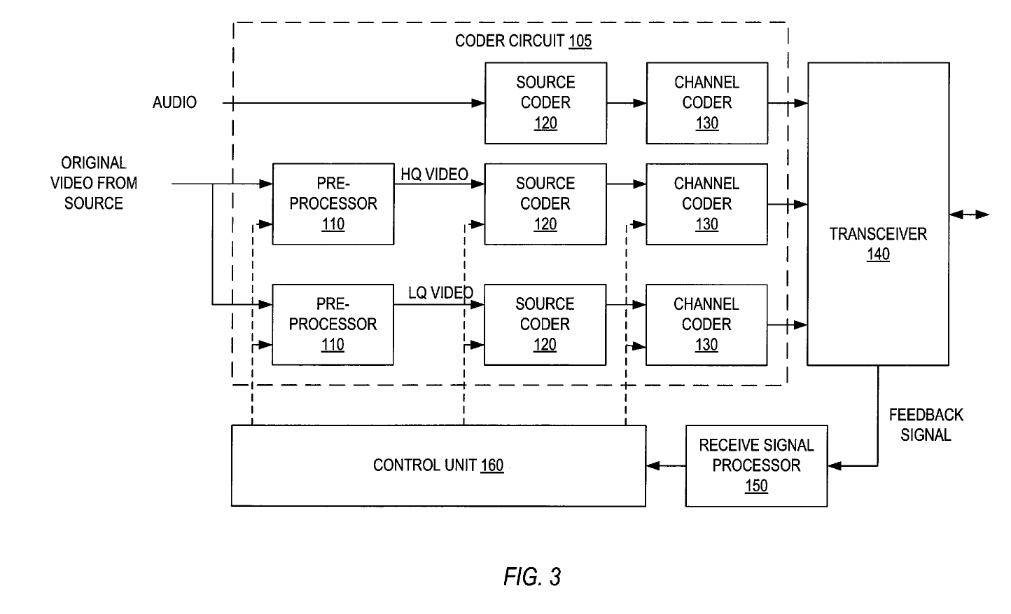

FIG. 3 illustrates an exemplary video transmission system (i.e., base station) 100 according to one exemplary embodiment. The video transmission system 100 includes a coding circuit 105 for coding video content to generate multiple encoded video streams, a transceiver circuit 140 for transmitting the video streams to the video receiving system 200, a receive signal processor 150 for processing feedback signals from the video receiving system 200, and a control unit 160 for controlling operation of the video transmission system 100. As will be described in greater detail below, the control unit 160 may adapt the source and channel coding for each of the video streams based on feedback received from the video receiving system 200.

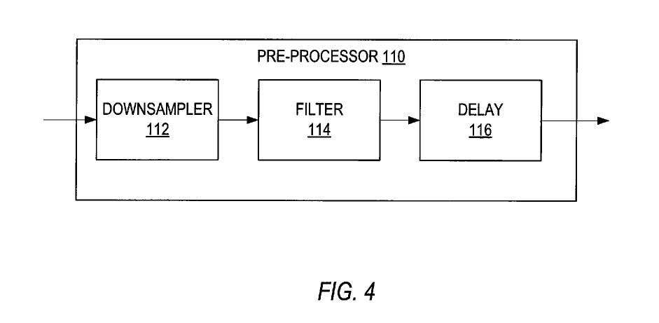

The coding circuit 105 includes a pre-processor 110, source coder 120, and channel coder 130 for each video stream. The coding circuit 105 also includes a source coder 120 and channel coder 130 for the associated audio stream. The pre-processor 110, shown in FIG. 4, includes a downsampler 112 to down-sample the video content to provide multiple video streams of a predetermined quality. The video stream is filtered by a filer 114 and time aligned with other video streams by a delay element 116. The time aligned sample streams from all pre-processors 110 are then input to respective source coders 120. The source coders 120 are preferably standard codecs, such as H.264 codecs for the video streams and eAAC codecs for the audio stream. Those skilled in the art will appreciate, however, that the present invention may use other video and audio codecs now known or later developed.

After source coding, the source-coded video streams and audio stream are input to respective channel coders 130. The channel coders 130 encode the video and audio streams with forward error correction (FEC) codes to protect against bit errors that may occur during transmission. The FEC codes may comprise, for example, convolutional codes or block codes. Preferably, a low code rate (e.g., 1/5) is used for the low quality stream to provide a relatively high level of error protection and a higher code rate e.g. (8/9) is used for the high quality stream to provide a relatively low level of error protection. A low code rate is also used for the audio stream.

The channel-encoded video streams and audio stream are then modulated and transmitted over separate channels to the video receiving system 200. The same modulation may be applied to each video stream and audio stream. Alternatively, different modulation schemes for the different video streams and audio stream. The transceiver 140 transmits the modulated symbols corresponding to each video stream and audio stream over separate communication channels (e.g., time slots or codes) to the video receiving system 200. The transceiver 140 may, for example, comprise a cellular transceiver operating according to known standards, such as the WCDMA and LTE standards. The HQ video stream is transmitted with a relatively low margin compared to the LQ video stream, and the LQ video stream is transmitted with a relatively high margin compared to the HQ video stream. For example, the high quality video stream may have a 1 dB margin. The increase in channel capacity required for 1 dB of additional margin of the HQ video stream can provide approximately 8 dB of margin for the LQ video stream. This provides 7 dB of additional margin for delivery of the video content, albeit with lower quality in some channel conditions, than using the channel capacity to increase the margin and/or protection of the HQ video stream. The increased margin may be obtained for example by providing greater error protection to the low quality video stream as compared to the high quality video stream. Ways of increasing the margin include increasing the transmit power and increasing the number of channel bits used to deliver a given number of data bits in the form of increased error correction bits or increased redundancy bits.

As will be described in more detail below, the video receiving system 200 for receiving multiple video streams of varying quality may send feedback signals to the video transmission system 100 to indicate the channel quality of the received video streams at the video receiving system 200. For example, the feedback signals may include the FER, BER, or other quality signal metrics for the received video streams. The feedback signals are processed by a receive signal processor 150 and supplied to the control unit 160. The control unit 160 may use the channel quality metrics fed back from the video receiving unit 200 to adjust the quality of the video streams. For example, the control unit 160 may change the resolution of the video streams by varying the sampling rates used by the downsamples 112. The control unit 150 may also vary the source and/or channel coding applied to the video streams responsive to changes in the quality metrics.

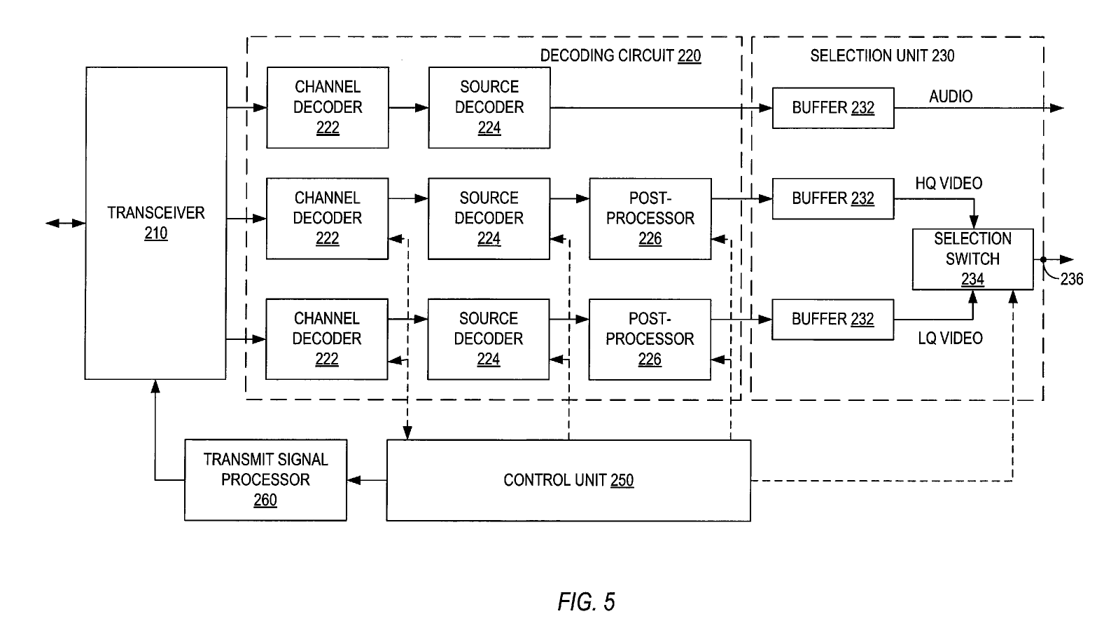

FIG. 5 illustrates an exemplary video receiving system 200. The video receiving system 200 comprises a transceiver 210 to receive the encoded video and audio streams over a mobile communications network, a decoding circuit 220 to decode the video and audio streams, a selection unit 230 to select one of the video streams for output to the display device 40, a transmit signal processor 260 to process feedback signals transmitted to the video transmission system 100, and a control unit 250 for controlling the video receiving system 200. The transceiver 210 may comprise, for example, a fully functional cellular transceiver operating according to any standard now known or later developed, such as the WCDMA standard or LTE standard. The encoded video and audio signals output from the transceiver 210 are supplied to the decoding circuit 220.

The decoding circuit 220 independently decodes each video stream and audio stream. The decoding circuit 220 includes a channel decoder 222 and source decoder 224 for each video stream and audio stream. The decoding circuit 220 also includes a post-processor 226 for each video stream. The channel decoders 222 detect and correct errors that may have occurred during transmission. The channel decoders 222 for the video streams may also generate channel quality metrics (e.g., FER, BER, etc.) indicative of the received channel quality of the received video streams. The source coder 224 decompress the video streams and audio signals output from the channel decoders 222 to generate video and audio signals suitable for output to the display devices 40. The decoded video streams may be further processed by post-processors 226. For example, the post-processors 226 may perform interpolation to scale the video frames so that the frames from both the HO and LQ video streams appear the same size to the user.

The decoded video and audio signals are input to a selection unit 230. The selection unit 230 includes a buffer 232 for each video and audio stream and a selection switch 234 to connect a selected one of the video buffers to a video output 236 of the selection unit 230. The control unit 250 receives the channel quality metrics from channel decoders 222 and controls the selection switch 234 to output a selected one of the video streams for playback on the display device 40. In general, the control unit 250 will select the highest quality video stream that is supported by the instantaneous channel conditions. If channel conditions are favorable, the control unit 250 will select the highest quality video stream for output to the display device 240. As channel conditions degrade, the FER/BER of the HQ video stream will increase. When the FER/BER reaches a predetermined threshold, the control unit 250 will select a LQ video stream to prevent interruption in the playback of the video content. When channel conditions improve again, the control unit 250 will switch back to the HQ video stream. Because the video streams are independently encoded, the HQ video stream is not needed to decode and play the LQ video stream. Therefore, the LQ video stream can be played even when the HQ video stream is unusable.

As noted above, the quality metrics used by the control unit 250 to select a video stream for playback and may be fed back to the video transmission system 100 to adapt the video quality of the transmitted video streams. The transmit signal processor 260 processes the feedback signals for transmission to the video receiving system 100 over an uplink control channel.

As previously indicated, both the HQ video stream and the LQ video stream are transmitted from the video transmission system 100 to the video receiving system 200. The video receiving system 200 preferably decodes both video streams and sends the decoded video streams to respective buffers 232. The decoder channel decoders 222 at the video receiving system 200 generate channel quality metrics for at least the HQ video stream and provides the channel quality metrics to the control unit 250. The quality metrics may, for example, comprise the FERs or BERs of the respective video streams after decoding. In some embodiments, the decoders 222 may provide the FER, BER, or other channel quality metric for both video streams. The control unit 250 selects one of the video streams for output based on the quality metrics.

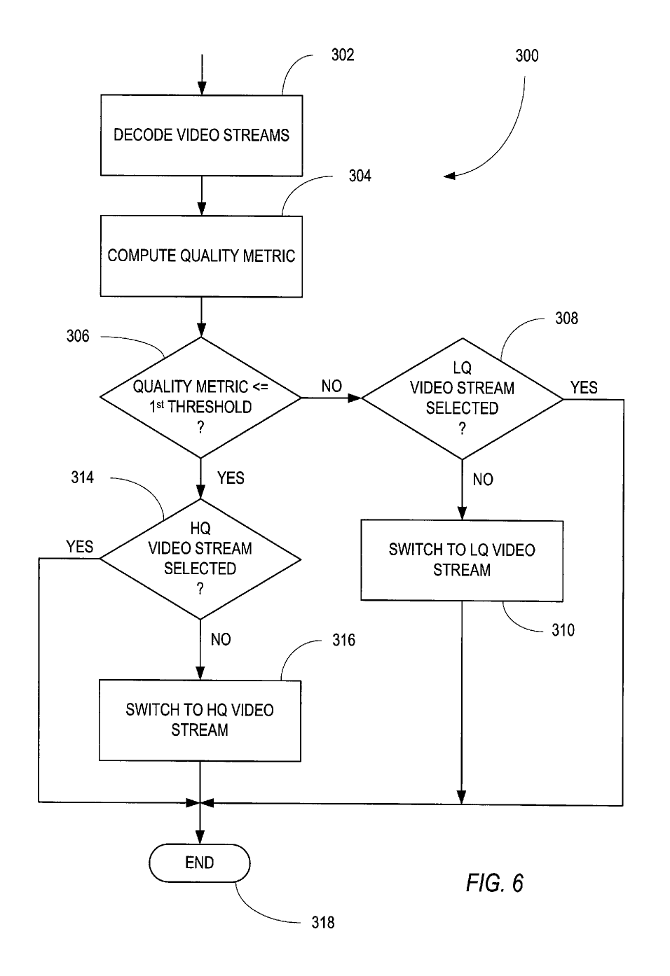

FIG. 6 illustrates an exemplary method 300 implemented by the video receiving system 200 for selecting a video stream for output. The video receiving system 200 decodes one or more of the video streams (block 302). It is assumed in this example that two video streams are received from the video transmission system: a HQ video stream and a LQ video stream. The channel decoders 222 at the video receiving system generate channel quality metrics for at least the HQ video stream (block 304). The quality metric may, for example, comprise the FER/BER of the HQ video stream. The control unit 250 compares the FER/BER of the HQ video stream to a first predetermined threshold (block 306). It may be noted that the quality metric in this example is an error rate and that the threshold is therefore an upper limit on the FER or BER. As channel conditions worsen, the FER and/or BER will increase. Therefore, the threshold can be set based on the maximum amount of errors that can be tolerated. If the FER/BER exceeds the first predetermined threshold, the control unit 250 determines whether the LQ stream is currently selected (block 308). If the LQ stream is not currently selected, the control unit 250 generates a control signal to switch the output to the LQ video stream (block 310). If the LQ stream is selected, the procedure ends (block 318) and the video receiving system 200 continues to output the LQ video stream. If the FER/BER is less than the first predetermined threshold, the control unit 250 determines whether the HQ stream is currently selected (block 314). If the HQ stream is not currently selected, the control unit 250 generates a control signal to switch the output to the HQ video stream (block 316). If the HQ stream is selected the procedure ends (block 318) and the video receiving system 200continues to output the HQ video stream.

In one exemplary embodiment of the present invention, decoding the LQ video stream is not required all of the time. If the channel quality of the HQ video stream is sufficient, processing resources can be conserved by disabling or turning off the channel decoder 222 and source decoder 224 for the LQ video stream. As the quality of the HQ video stream deteriorates, decoding for the LQ video stream can be enabled. Preferably, decoding of the LQ video stream is enabled before switching the LQ video stream so that the buffer 232 for the LO video stream has time to fill. A second predetermined threshold lower than the first predetermined threshold can be used to enable and disable decoding for the LQ video stream. When the channel quality of the HQ video stream exceeds the second predetermined threshold, the control unit 250 can enable decoding for the LQ video stream. When the channel quality of the HQ video stream remains below the second predetermined threshold for a specified period of time, decoding for the LQ stream can be disabled.

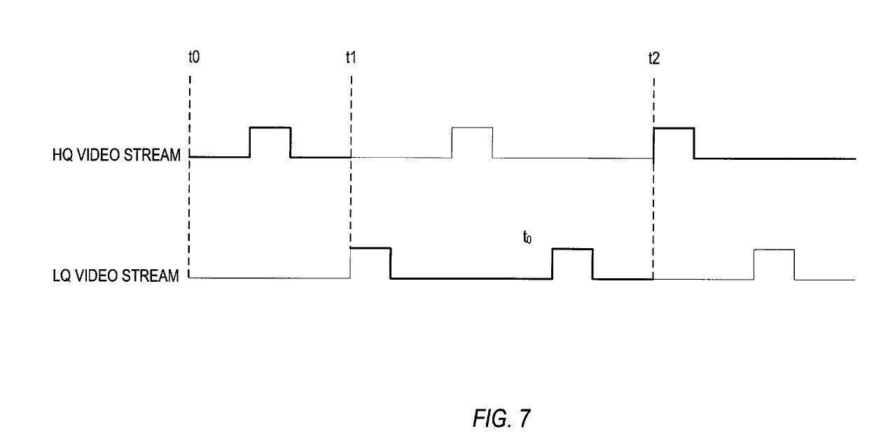

In order to switch smoothly between the HQ and LQ video streams, the control unit 250 can control the switch timing of the selection circuit 230 so that the transition from one video stream to another is coincident with the occurrence of an I-frame in the video stream being selected. FIG. 7 is a timing diagram illustrating the switch timing in one exemplary embodiment of the invention. The timing of the I-frames, shown as pulses, in the HQ and LQ video streams is preferably synchronized so that the time relationship between I-frames in the HQ and LQ streams respectively is known to the control unit 250. As shown in FIG. 7, the HQ stream is selected at time to. The channel quality of the HQ stream subsequently degrades and the control unit 250 switches to the LQ video stream at time t₁, which is coincident with an I-frame in the LQ stream. When the channel quality of the HQ stream improves, the control unit 250 switches back to the HQ video stream at time t₂, which is coincident with an I-frame in the HQ video stream.

In one exemplary embodiment, the video transmission system 100 can adapt the quality of the high quality, the low quality video stream, or both based on information received from the video receiving system 200. The ability to adapt the quality of the video streams is useful to prevent the video receiving system 200 from dwelling on the low quality video stream for a long period of time. For example, when channel conditions are unfavorable, the video receiving system 200 may be unable to properly receive and decode the HQ video stream. If poor channel conditions persist, the LQ video stream will remain selected and the quality of the video output to the user for viewing will be low.

One possible solution to this problem is to provide one or more intermediate quality video streams between the HQ video stream and the LQ video stream. The video receiving system 100 could then select the highest quality video stream that can be supported by the current channel conditions. However, each transmitted video stream consumes additional bandwidth, which could be used for other purposes. On the other hand, the bandwidth dedicated to the HQ stream is essentially wasted if the video receiving system 200 selects the LQ video stream for a long period of time.

According to one exemplary embodiment of the present invention, the quality of the high quality video stream, the low quality video stream, or both, is adapted based on feedback received from the video receiving system 200 to prevent waste of resources and to provide a better viewing experience for the user. When the video receiving system 200 dwells for a long time on the LQ video stream, the video transmission system 200 can adjust the video quality of one or more of the video streams downward. Conversely, when video receiving system 200 dwells for a long period of time on the high quality video stream, the video quality of one or more of the video streams can be adjusted upward.

Reducing the video quality can be accomplished in a number of different ways. One way to reduce the video quality of a video stream is to reduce the horizontal resolution, vertical resolution, or color depth of the frames in the video stream. Another method of reducing the video quality is to change the compression ratio used by the source coder 120 at the video transmission system 100. Each of these approaches reduces the number of source coded bits that are transmitted to the video receiving system 200. When the data rate of the source coded video stream is reduced, there is also a corresponding reduction in the signal-to-noise ratio required to receive the video stream with a targeted error rate. The reduction in the number of source bits also increases the power margin of the transmitted video streams. The additional margin gained by reducing the number of source coded bits can be used by increasing the redundancy (i.e., lowering the code rate) applied by the channel coder 130 to increase the error protection. Alternatively, the additional margin can be used by decreasing the transmit data rate of the channel coded bits or increasing the transmit power.

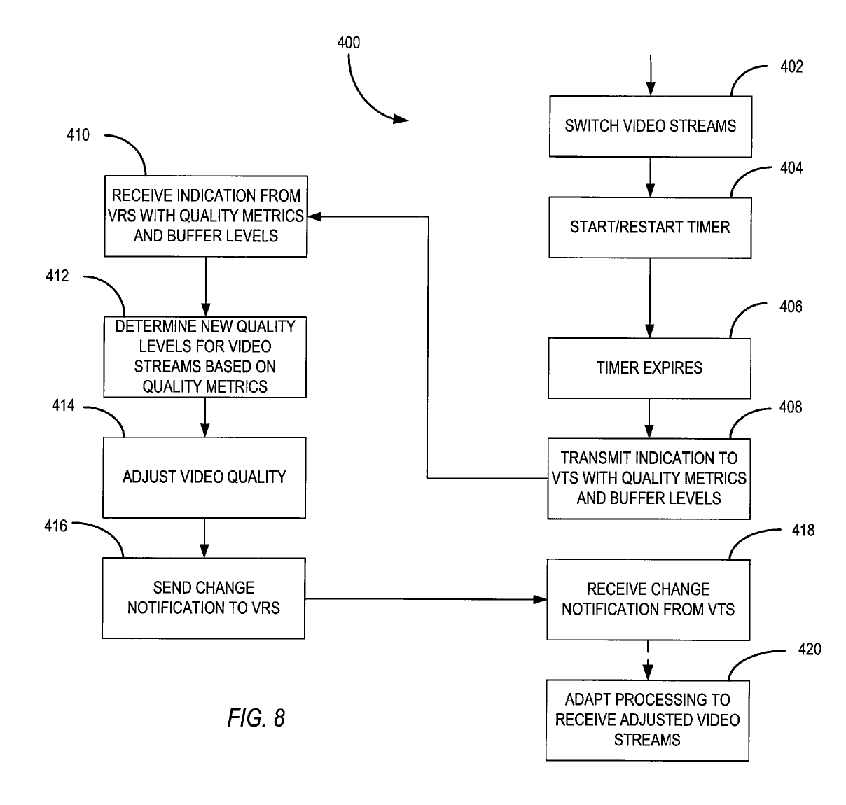

FIG. 8 illustrates an exemplary method 400 for adjusting the video quality of one or more video streams according to one exemplary embodiment of the present invention. The method begins when the video receiving system 200 switches between different video streams (block 402). The selection and switching of video streams may be performed as shown in FIG. 6. When the video receiving system 200 switches from one video stream to another, the video receiving system starts a timer (block 404). If the timer is currently running, the timer is restarted. If the channel conditions remain unchanged for a long period of time, the timer will eventually expire (block 406). When the timer expires, the video receiving system 200 transmits an indication to the video transmission system 100 indicating that a change in the quality of the transmitted video streams may be needed (block 408). The video receiving system also transmits the current channel quality metrics and buffer levels for each of the video streams to the video transmission system 100.

The video transmission system 100 receives the indication from the video receiving system 200 (block 410) and determines new quality levels for the video streams based on the quality metrics (block 412). After determining the new quality levels for the video streams, the video transmission system 100 makes adjusts the video quality of the video streams (block 414). As noted previously, adjustment of the video quality may include varying the resolution or color depth of the video streams output by the pre-processors 110. In addition, the compression ratio of the source coding applied by the source coders 120 can be adjusted. When the quality of the video streams is changed, the video transmission system 100 sends a change notification to the video receiving system 200 (block 416). Those skilled in the art will appreciate that the video receiving system 200 may determine at block 412 that no change in video quality is needed. In this case, the change notification may indicate that no change has been made.

When the video receiving system 200 receives a change notification from the video transmission system 100 (block 418), the video receiving system 200 adopts source decoding, channel decoding, or post-processing algorithms accordingly (block 420). The change notification sent by the video receiving system 100 may indicate the timing of the change in source and/or channel coding. The video transmission system 200 may also manipulate the source and channel coding to allow the video stream to be transmitted at a temporarily faster rate to fill up the buffers at the video receiving system 200.

The present invention mitigates the effects of fast fading by enabling the video receiving system 200 to autonomously switch to a low quality video stream when channel conditions will not support the high quality video stream. By switching to the low quality video stream, the video receiving system 200 can avoid interruption of the video program. The present invention may be applied to video streams and other multimedia streams.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. A method of receiving video at a mobile communication device, said method comprising:
receiving a high quality video stream corresponding to selected video content;
receiving a low quality video stream corresponding to the selected video content and synchronized with said high quality video stream, said low quality video stream being independently coded and transmitted so as to provide a relatively high margin compared to the high quality video stream;
decoding said high quality video stream in a first channel decoder and a first source decoder;
decoding said low quality video stream in a second channel decoder and a second source decoder;
generating a first quality metric indicative of a received channel quality of the high quality video stream; and
switching between high quality and low quality video streams based on said first quality metric.

2. The method of claim 1 wherein switching between high quality and low quality video streams based on said first quality metric comprises switching from the high quality video stream to the low quality video stream when the first channel quality metric exceeds a first predetermined threshold.

3. The method of claim 2 wherein decoding said low quality video stream comprises channel decoding and source decoding the low quality video stream only when the first channel quality metric exceeds a second predetermined threshold.

4. The method of claim 3 wherein the second predetermined threshold is lower than the first predetermined threshold.

5. The method of claim 1 further comprising sending said first channel quality metric to a video transmission system for adapting the video quality of at least said high quality video stream responsive to said first channel quality metric.

6. The method of claim 1 further comprising generating a second channel quality metric indicative of the received channel quality metric of the low quality video stream and sending said first and second channel quality metrics to a video transmission system for adapting the video quality of said high quality and low quality video streams.

7. The method of claim 1 wherein switching between high quality and low quality video streams based on said first quality metric comprises switching to a selected one of the high quality and low quality video streams at a time coincident with the start of an I-frame in the selected video stream.

8. A communication device having a display for receiving a video stream, said communication device comprising:
a receiver to receive high quality and low quality video streams corresponding to selected video content from a video transmission device, said low quality video stream being independently coded and transmitted so as to provide a relatively high margin compared to the high quality video stream;
a decoding circuit configured to:
decode said high quality video stream to generate a high quality video stream;
generate a first channel quality metric for the high quality video stream;
decode said low quality video stream to generate a low quality video stream;
a selection circuit for switching between said high quality and low quality video streams for output to said display; and
a control unit for controlling said selection circuit based on the first channel quality metric.

9. The communication device of claim 8 wherein the control unit is configured to switch from the high quality video stream to the low quality video stream when the first channel quality metric exceeds a first predetermined threshold.

10. The communication device of claim 9 wherein the control unit is configured to selectively enable and disable the decoding circuit for the low quality video stream based on said first channel quality metric.

11. The communication device of claim 10 wherein the control unit is configured to selectively enable the decoding circuit for the low quality video stream when said first channel quality metric is below a second predetermined threshold.

12. The communication device of claim 11 wherein the first predetermined threshold is lower than the second predetermined threshold.

13. The communication device of claim 8 wherein the control unit is further configured to send said first channel quality metric to a video transmission system for adapting source coding of said high quality video stream.

14. The communication device of claim 8 wherein the decoding circuit is further configured to generate a second channel quality metric indicative of the channel quality of the low quality video stream and wherein said control unit is further configured to send said first and second channel quality metrics to a video transmission system for adapting the video quality of at least said high quality video stream.

15. The communication device of claim 8 wherein the control unit is configured to switch to a selected one of the high quality and low quality video streams at a time coincident with the start of an I-frame in the selected video stream.

16. A method of transmitting video to a remote communication device over a wireless communication network, said method comprising:
receiving selected video content from a video source;
encoding the selected video content in a first source coder and a first channel coder to generate a high quality video stream containing the selected video content;
independently encoding the selected video content in a second source coder and a second channel coder to generate a low quality video stream containing the selected video content;
transmitting said high quality video stream to the mobile communication device over a first channel; and
transmitting the low quality video stream to the mobile communication device over a second channel with a relatively high power margin compared to the high quality video stream.

17. The method of claim 16 further comprising:
receiving channel quality feedback from said mobile terminal over an uplink channel:
varying the video quality of at least the high quality video stream responsive to said channel quality feedback from said mobile terminal.

18. The method of claim 17 wherein varying the video quality of the high quality video stream comprises varying the resolution or color depth of the video stream.

19. The method of claim 17 wherein varying the video quality of the high quality video stream comprises varying the source coding and/or channel coding video stream.

20. The method of claim 17 further comprising varying the video quality of the low quality video stream responsive to said channel quality feedback from said mobile terminal.

21. A video transmission system for transmitting video to a remote communication device over a wireless communication network, said video transmission comprising:
a coding circuit configured to:
code video content to generate a high quality video stream;
code video content to generate a low quality video stream;
a transmitter for transmitting said high quality video stream and said low quality video stream over respective channels to the mobile terminal; and
a control unit for controlling the said coding circuit and said transmitter to transmit said high quality video stream with a relatively low margin and to transmit said low quality video stream with a relatively high margin.

22. The video transmission system of claim 21 wherein the control unit is configured to:
receive channel quality feedback from said mobile terminal over an uplink channel; and
vary the video quality of the high quality video stream responsive to said channel quality feedback from said mobile terminal.

23. The video transmission system of claim 22 wherein the control unit is configured to vary the resolution and/or color depth of the high quality video stream responsive to said channel quality feedback.

24. The video transmission system of claim 22 wherein the control unit is configured to vary the source coding and/or channel coding of the high quality video stream responsive to said channel quality feedback.

25. The video transmission system of claim 22 further the control unit is configured to vary the video quality of the low quality video stream responsive to said channel quality feedback from said mobile terminal.
